(19) United States
(12) Patent Application Publication
(10) Pub. No.: US 2009/0188896 A1
(43) Pub. Date: Jul. 30, 2009

(54) GMAW System Having Multiple Independent Wire Feeds

(75) Inventors: Alexander D. Khakhalev, Troy, MI (US); Jay Hampton, Lenox, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC, DETROIT, MI (US)

(21) Appl. No.: 12/019,660

(22) Filed: Jan. 25, 2008

(51) Int. Cl. B23K 9/16

(52) U.S. Cl. 219/74; 219/137 R

(57) ABSTRACT

A gas metal arc welding system comprising, and a method of welding a plurality of workpieces utilizing, a plurality of individually selectable and separately controlled wire feeds, wherein the feeds preferably present differing wire diameters and compositions and predetermined wire contributions are combined during welding so as to present a weld pool and joint having aggregate properties.

### BACKGROUND OF THE INVENTION

1. Technical Field

The present invention relates to gas metal arc welding (GMAW) systems, and more particularly, to a GMAW system having a plurality of individually selectable and separately controlled wire feeds that function to present greater flexibility in selection of appropriate wire for different welding conditions.

2. Discussion of Prior Art

Gas Metal Arc Welding (GMAW) is a commonly employed method of welding metal workpieces in industrial application. As represented in prior art FIG. 1, GMAW systems typically include a torch (or welding gun) 1 having a nozzle 2, a power supply 3, a wire feed unit 4 configured to feed a wire 5 to the torch 1, and a shielding gas supply/network 6. In preferred use, the welding torch 1 is oriented so as to maintain a consistent torch tip-to-work distance from pre-positioned workpieces 7. As shown in prior art FIG. 1a, the welding gun includes an electrically energized contact tip 8 that is axially aligned inside the gun nozzle 2, and configured to charge by contacting the wire 5. The applied voltage between the charged wire 5 and workpieces 7 produce an intermediate electric arc. The heat energy generated by the arc fuses the wire 5 in a globular, short-circuiting, or spray mode and penetrates the workpieces 7 to form the weld. Thus, a GMAW welding process typically comprises an arc initiation period, a main course of welding period (that typically produces an end crater), and a subsequent crater fill period.

With regards to the present invention, a wire feed, such as the type involving a wound wire about a reel and a drive mechanism for advancing the wire through an electrode conduit defined by the torch, is typically utilized to introduce wire material into a heat zone predominately defined by the arc. Most conventional units provide the wire with variable feed rate in response to joint size and required deposition rate. For example, some wire feeders present the wire at rates from 50 to 1200 ipm. Finally, it is also known in the art to utilize twin wire feeds presenting identical compositions and feed rates where thicker workpieces are to be welded.

GMAW wires typically present either solid or composite configurations, wherein solid wires may be formed of steel, aluminum or relative alloys, and composite types include flux or metal-core wires. For example, silicon bronze wires are often provided for brazing applications. The preferred wire size and composition is selected according to factors such as welded joint service properties, required deposition rate, and joint configuration. In some cases, the amount and type of evaporated material anticipated to be lost by the base material during welding is also considered, so that a wire composition rich in the lost material could be provided.

When these factors are not properly considered operational and performance concerns arise. For example, many operators overlook the efficiencies they can gain by changing the wire in a welding application. Improper wire selection may contribute to low production rate, poor weld quality, excessive spatter, and an excessively large crater at the end, and the need for post-welding processing. Further, where an improper wire composition is selected, the weld joint may present a shearing strength substantially less than that of the base material, and therefore a premature fracture zone in the assembly

Other concerns involving conventional wire feed units having invariable feed rate control are also experienced in the prior art. For example, it is appreciated by those of ordinary skill in the art that optimal feed rates for the main joint welding period often yield excessive spatter and weld pool distortion during crater fill and arc initiation due to unequal initial forces and instability, while optimal feed rates for arc initiation and crater fill are insufficient to provide the necessary material contribution during main course of welding. Moreover, where the heat energy input is in error, the wire feed rate cannot be adjusted in real-time.

Thus, while providing the material necessary to effect proper welding, conventional GMAW wire feed units continue to present various concerns. Consequently, there remains a need in the art for a wire feed unit that addresses these concerns by providing greater flexibility and control with respect to wire contribution.

### SUMMARY OF THE INVENTION

Responsive to this need, the present invention concerns a GMAW system having multiple independent wire feeds of preferably differing wire compositions and diameters. Among other things, the invention is useful for providing precision control of welding pool shape, greater flexibility in determining weld joint composition, and reduced spatter and smooth arc initiation. The improved welding system results in more efficient welding compared to prior art systems. For example, heat energy data and/or observation is preferably considered, so that the most energy efficient wire feed rate for each feed can be utilized during arc initiation, main course of welding, and crater fill. Moreover, down-time associated with wire reel change-over is also reduced, as it is appreciated that the inventive system may be properly utilized over a substantially wider range of applications. Finally, utility of invention also includes enabling real-time control and adjustment of heat input for complex metal combinations and stack-ups.

A first aspect of the present invention concerns a gas metal arc welding system adapted for welding a plurality of workpieces during a welding process. The system includes a GMAW torch, a plurality of wires, and at least one advancing mechanism. The GMAW torch includes a novel contact tip defining a plurality of holes/openings for welding wire feeding. The torch and workpieces are cooperatively configured to produce an intermediate dynamic electric arc and a heated zone having an operating temperature adjacent the arc. Each of the wires presents a distal end and preferably different diameters, chemical compositions, and physical and mechanical properties. The openings are configured to concurrently receive the wires, such that each of the distal ends enter the zone. Finally, the advancing mechanism is configured to advance each of the wires into the zone at a predetermined feed rate.

A second aspect of the present invention concerns a method of welding a plurality of workpieces utilizing multiple independent wire feeds, wherein each workpiece presents a thickness and composition and each feed presents a wire diameter and composition further presenting tensile and shear strengths, a melting temperature, and a dynamic viscosity and cohesive force when melted. The method includes a plurality of steps including securing the feeds relative to the workpieces. A desired first total wire contribution (deposition or consumption rate) is based on the workpiece thicknesses and compositions. A first feed rate that would produce the desired wire contribution is then determined. Finally, wire of predetermined diameter and physical properties autonomously advance at determined feed rate, so as to produce the first wire contribution.

Other aspects and advantages of the present invention will be apparent from the following detailed description of the preferred embodiment(s) and the accompanying drawing figures.

### BRIEF DESCRIPTION OF DRAWINGS

Preferred embodiments of the invention are described in detail below with reference to the attached drawing figures, wherein:

FIG. 1 is a schematic elevation of a prior art GMAW system, particularly illustrating a torch, power supply, wire feed unit, and a shielding gas supply tank and network;

FIG. 1a is a perspective view of a prior art torch nozzle, particularly illustrating a single wire feed, shielding gas conduit, and conventional contact tip;

FIG. 2 is a perspective view of a plurality of workpieces being welded by a GMAW torch having multiple wire feeds and associative arcs in accordance with a preferred embodiment of the invention, particularly illustrating an arc zone and an aggregate wire contribution being delivered to a weld pool;

FIG. 3 is a partial elevation view of a plurality of workpieces and a multi-wire feed GMAW torch nozzle in accordance with a preferred embodiment of the invention, particularly illustrating a heat zone sensor, and the interrelation between a plurality of wire feeds and a contact tip;

FIG. 3a is a cross-section of the contact tip and wire feeds shown in FIG. 3 taken along line A-A therein;

FIG. 3b is a partial elevation view of a tapered contact tip and converging wire feeds, in accordance with a preferred embodiment of the present invention;

FIG. 4 is a cross-sectional view of a contact tip and wire feeds in accordance with a preferred embodiment of the invention, particularly illustrating three wires and an extra slot;

FIG. 5 is a schematic elevation of a multi-wire feed GMAW system in accordance with a preferred embodiment of the present invention, particularly illustrating a plurality of advancing mechanisms, wire feed and heat zone sensors, and a controller communicatively coupled thereto;

FIG. 6 is a perspective view of an input shaft and clutch assembly interacting with a plurality of three wire feed reels, in accordance with a preferred embodiment of the invention, wherein the intermediate reel is disengaged;

FIG. 7 is a perspective view of a singular drive mechanism including a bevel gear transmission coupled to a plurality of three wire feed reels, in accordance with a preferred embodiment of the invention, wherein an adjacent reel is disengaged; and

FIG. 8 is a partial elevation view of a multi-wire feed GMAW system welding a complex stack-up, in accordance with a preferred method of the present invention, particularly illustrating the applied wire feeds during a plurality of six different periods of a welding process.

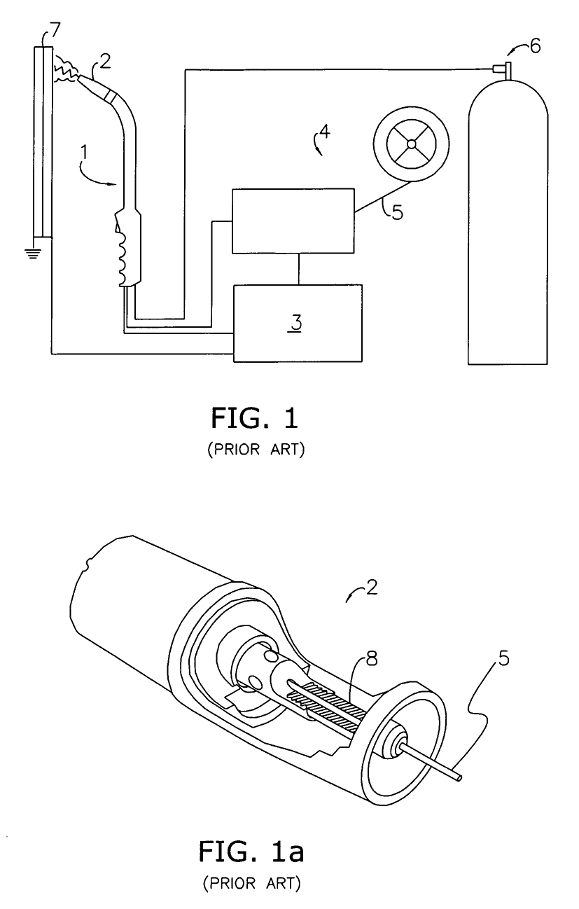

### DETAILED DESCRIPTION OF THE INVENTION

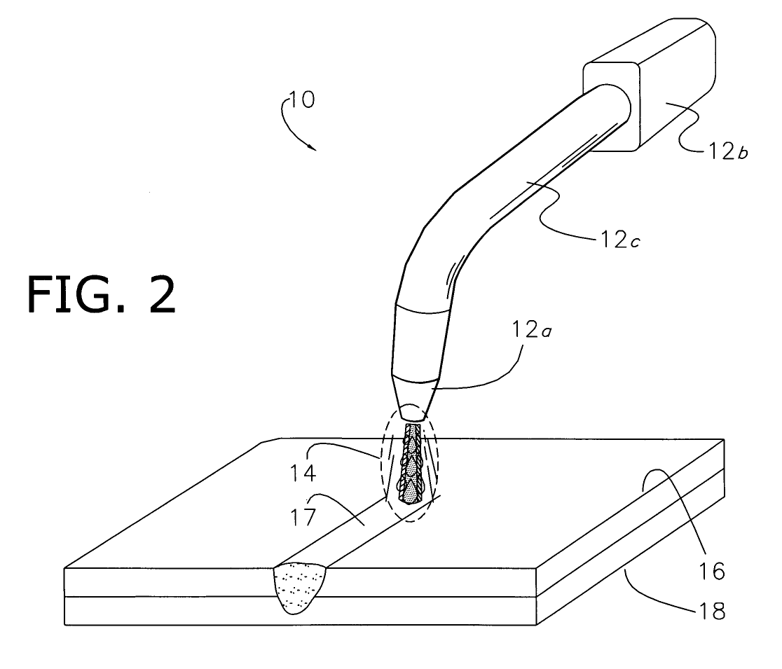

As shown in FIGS. 2-8, the present invention concerns a gas metal arc welding (GMAW) system 10 having a plurality of independent and separately controllable wire feeds. The system 10 includes a torch 12 comprising a modified nozzle 12a, handle 12b (where manually operated), and a body 12c. As is known in the art, the torch 12 functions to produce an electric arc and associative heat zone 14 having a minimum operating temperature sufficient to melt the base material of a plurality of workpieces 16,18, wherein the specifications of welding (e.g., operating temperature, travel speed, voltage, etc.) are dependent upon workpiece size and composition. For example, it is appreciated by those of ordinary skill in the art that gas metal arc welding of 16-gauge mild steel requires at least 160 amps with 100 percent carbon dioxide shielding gas. However, it is appreciated that the present invention may be used to weld common commercial metal workpieces (e.g., low-carbon steel, high-strength steel, low-alloy steel, stainless steel, and aluminum), and to that end, functions to expand the range of base materials suitable for welding without changeover. Finally, for the purposes of this invention, the heat zone 14 generally consists of the electric arc between the welding wire and workpiece and the space immediately adjacent the arc (FIG. 2).

As previously mentioned, it is also appreciated that proper electrode diameter is related to the thickness and composition of the workpieces to be welded, wherein a smaller wire diameter is preferred when welding thinner metal. Moreover, the output voltage of the GMAW power supply must also be matched with the voltage rating of the electrode wire selected.

The inclusion of multiple independent wire feeds enables the inventive system 10 to more facilely meet these preferences and requirements, by modifying the wire material contribution to simulate a large variety of total wire compositions and diameters. In the illustrated embodiment, an exemplary plurality of three wire feeds 20a,b,c is presented; however, it is appreciated that a greater or lesser plurality may be utilized, wherein an increase in the number of feeds is directly proportional to system flexibility and variety and inversely proportional to system complexity and nozzle crowding.

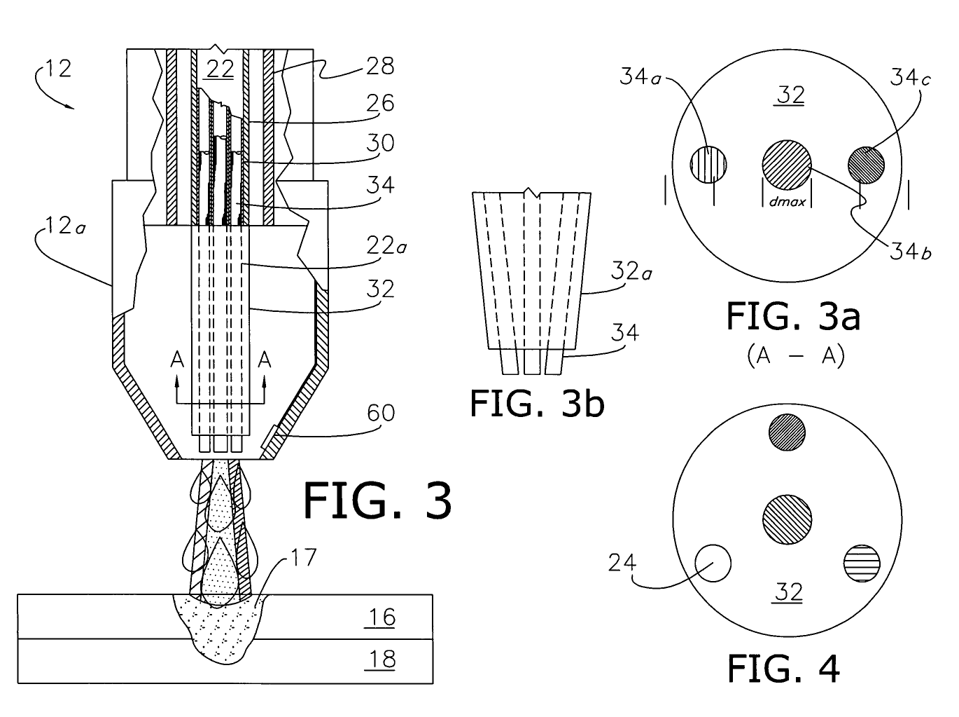

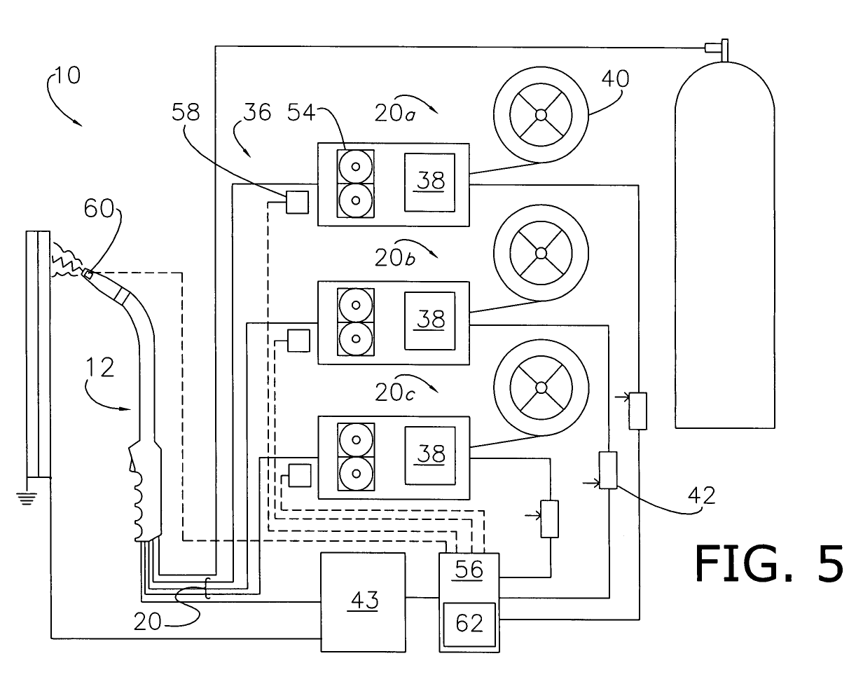

The system includes a modified torch 12 with the contact tip 32 defining at least one, and more preferably, a plurality of openings 22 (FIG. 3) configured to receive the feeds 20. The torch 12 preferably defines a plurality of openings greater than the number of feeds, so as to include at least one extra hole 24 for facilitating the provision of additional wire feeds or other provisions, such as shielding gas flow. In FIG. 4, for example, a plurality of four openings 22 are defined, with one being an extra hole 24. Thus, the welding torch body 12c and nozzle 12a are configured to cooperatively define the openings 22. As shown in FIG. 3, the torch body 12c may, more particularly, include a singular electrode conduit 26 coaxially aligned with a shielding gas conduit 28. Within the electrode conduit 26 a plurality of sleeves 30 are preferably disposed, so as to separate the wire feeds 20a,b,c. The sleeves 30 are therefore formed of insulative material.

The inner-workings of the nozzle 12a include an electrically energized contact tip 32 (FIGS. 3-4). As in singular wire feeds, the contact tip 32 functions to contact and thereby energize the wire feeds 20, as the feeds 20 are continually directed into the arc zone 14. As such, the inventive tip 32 is formed of conductive material such as copper and defines the distal portions 22a of the openings. The sleeves 30 preferably present flexible end sections that enable connection with a respective distal portion 22a. So as to accommodate a plurality of wire feeds 20, the inventive tip 32 presents a diameter preferably slightly larger than a comparable conventional contact tip. For example, a suitable inventive tip 32 for use with conventional torches may present a diameter of approximately 10 mm.

The distal portions 22a are preferably parallel (FIG. 3) and spaced to enable collective fusion of the wire feeds by a single arc. As such, where dₘₐₓ equals the largest of the portion diameters, adjacent portions 22a are preferably spaced not greater than five times dmax, and more preferably, not greater than two times dₘₐₓ (FIG. 3a). Alternatively, the tip 32 may be formed of a more heat resistant and durable material such as metal ceramic, wherein copper inserts (not shown) are provided for energizing the wires. Alternative tip 32 configurations may further be utilized, such as a tapered tip 32a (FIG. 3b) that converges the wire feeds towards a point within the arc zone 14, so as to promote wire material diffusion/intermixing and increase arc heat flux density.

Each feed 20 includes an elongated wire (i.e., wire segment) 34 presenting a wire composition, length (l), and diameter (d); as such, a plurality of three wires 34a,b,c are reflected in the illustrated embodiment (FIGS. 3-4). Each wire composition preferably presents a melting temperature less than the minimum operating temperature of the zone 14. Each diameter is configured so that the wire 34 is tightly received (i.e., within a 0.15 mm tolerance) in the respective distal portion 22a , as said tolerance is necessary to ensure that contact is maintained therebetween. Each wire 34 preferably presents a substantially different (e.g., at least 15% greater or less than) diameter in comparison to each of the remaining diameters. More preferably, each diameter is at least 20%, and most preferably 25%, greater or less than each of the remaining diameters. For example, where a first wire presents a 1.2 mm diameter, a second wire preferably presents a diameter not less than 1.4 mm, and a third wire preferably presents a diameter not greater than 0.9 mm.

Each wire 34 preferably presents a substantially different composition, so as to provide increased flexibility and variety of application, wherein the term “substantially different composition” shall encompass functionally non-equivalent material constituencies in the context of GMAW. The wire compositions are preferably selected so as to provide an operator with differing alternatives and the ability to change the mechanical properties of the weld joint. More particularly, the preferred wires 34 are formed of substantially differing compositions, such that each wire 34 presents a different tensile (or shearing) strength, which presents the system 10 with variety of material selection for providing desired joint strengths. The preferred wires 34 may be formed of substantially differing compositions, such that each wire presents a different fluidity (or dynamic viscosity) when molten. This presents the system 10 with a variety of material selection to shape and control the weld pool 17 (FIG. 2). More preferably, each wire presents a fluidity at least 25% greater or less than that of each of the other wires 34. Finally, the preferred wires 34 may also be formed of substantially differing compositions, such that each wire 34 presents a different interstitial or molecular force, such as metallic bond, ionic bond, electromagnetic, or cohesive force when molten. With regards to cohesion, for example, it is appreciated that the wire composition presenting the highest cohesive force (i.e., surface tension) may be utilized to minimize spatter during arc initiation, as such material is more likely to maintain its integrity.

In another aspect of the invention, the system 10 is configured to present differing wire feed rates, and more preferably each feed rate is individually controllable, so as to be separately adjusted. To that end, the system 10 further includes at least one advancing mechanism 36 drivenly coupled to each of the wire feeds 20 (FIG. 5). More preferably, a plurality of independently operable mechanisms 36 having separate motors 38 are drivenly coupled to an equal plurality of feeds 20, wherein each mechanism 36 engages only one feed 20. Finally, as is known in the art, each feed 20 further includes a rotatable wire reel 40 that stores a wound separate one of the wires 34, and is drivenly rotated by a respective mechanism 36.

Variability of feed rate may be provided, for example, by altering the power input to the mechanisms 36, as is also known in the art. For example, as diagrammatically shown in FIG. 4, a plurality of potentiometers 42 may be intermediately posed between a power source 43 and the motors 38 to effect variable motor output. The potentiometers 42 are incrementally, and more preferably, slidably adjustable.

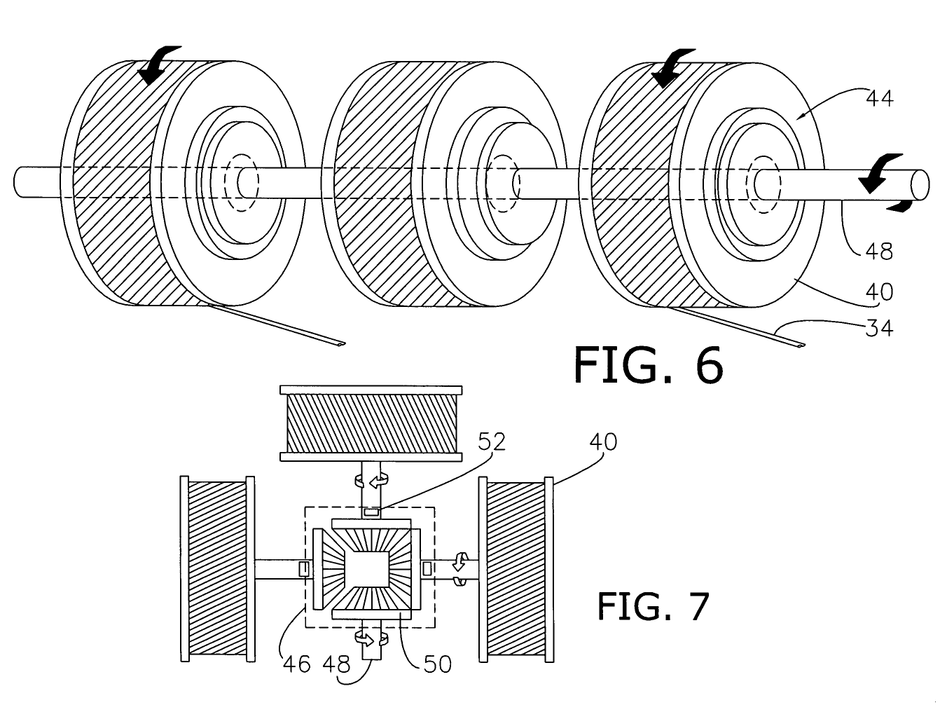

Thus, it is appreciated that a preferred embodiment of the system 10 contemplates utilizing a plurality of conventional wire feed mechanisms 36 to drive an equal plurality of feeds 20, wherein each mechanism 36 is configured to advance a respective wire segment 34 to the inventive contact tip 32. Alternatively, however, a singular drive mechanism 36 may be used to drive the feeds 20. For example, the mechanisms 36 may include a clutch 44 configured to selectively cause a singular motor 38 and input drive shaft 46 to engage and disengage a respective reel 40. FIG. 6 generally depicts an input shaft and clutch assembly engaging a plurality of three wire feed reels 40, wherein the outer two reels are engaged and the middle reel is disengaged.

As shown in FIG. 7, the singular mechanism 36 may be coupled with a complex transmission (e.g., gear box) 48 configured to selectively and adjustably engage the wire feeds 20. In this configuration, the input shaft 46 drives the transmission 48, so as to produce the intended output. In the exemplary transmission 48 shown in FIG. 7, a series of bevel gears 50 and magnetic relays 52 for switching are employed to effect selective rotational translation. In FIG. 7, two of three reels 40 are engaged to and being driven by shaft 46 through the transmission 48. In a further alternative configured to provide even greater adjustability, a plurality of differing drive mechanisms 36 and at least one transmission 48 may be cooperatively configured, such that each of the mechanisms 36 are able to selectively engage each of the feeds 20.

Finally, each of the preferred drive mechanisms 36 further include a set of vertically stacked rollers 54 (FIG. 5). As is known in the art, the rollers 54 are cooperatively sized and configured to grip and further advance the wires 34, so as to guide them into the openings 22.

In a preferred embodiment, the system 10 also includes a controller 56 (FIG. 5) communicatively coupled to the mechanisms 36 and torch 12. The controller 56 is programmably configured to autonomously actuate each of the mechanisms 36 separately, modify their respective feed rates, and actuate the torch 12 after confirming proper wire feeding. The preferred controller 56 is therefore configured to receive input, and cause the feed rates to be adjusted based on the input. In this regard, the preferred system 10 further includes sensory technology for determining application characteristics. For example, a first sensor 58 (FIG. 5), operable to detect the actual motion of a wire 34, may be positioned near the exit of each reel 40, so that the sensor 58 is able to detect the end of the respective wire 34 and then alert the controller 56 to terminate the welding process.

A second sensor 60, operable to determine an arc zone characteristic, may be positioned relative to the torch nozzle 12a and zone 14 during the welding process. For example, as best shown in FIG. 3, the sensor 60 may be a thermocouple attached to the nozzle 12a and configured to detect the zone temperature. In this configuration, the preferred sensor 60 further generates correlative arc zone characteristic data related to the temperature or a derivative thereof, such as an estimated or extrapolated heat input energy value. Both the first and second sensors 58,60 are communicatively coupled to the controller 56 (i.e., through suitable short-range wireless technology or hard-wire), so as to be able to convey the data to the controller 56 as an input signal. The controller 56 is configured to modify a continuous output signal based on the received input signal. Thus, the system 10 preferably presents a closed-loop feedback control system.

In operation, after receiving set-up information from the operator regarding the application (e.g., workpiece thickness, stack configuration, and composition, etc.), the preferred controller 56 is programmably configured to determine a desired total wire contribution. The controller 56 is configured to then determine a feed rate for each of the wire feeds 20 that would yield the desired contribution. To that end, the preferred controller 56 includes a queriable database 62 of contributions and feed rates for a given set of wire feeds 20 and applications.

Alternatively or in addition to the database 62, a complex algorithm that calculates resultant pool and joint characteristics based upon the material properties of the wire feeds 20 and further optimizes (i.e., determines the preferred rates for) the feeds 20 in order to achieve a pool or joint characteristic may be employed. Where present, the algorithmic determinations for a given application may then be stored in the database 62 for future recall. Once the feed rates are determined, the preferred controller 56 autonomously actuates the torch 12 and advances the feeds 20 into the zone 14 at the feed rates by sending the appropriate signal to the drive mechanisms 36.

In a second mode of operation, the preferred controller 56 is further configured to determine a total wire contribution for each of a plurality of asynchronous application periods (or phases), and to achieve these contributions by determining separate feed rates for each of the wire feeds 20 during that period. For example, an arc initiation contribution may be determined and produced over a first period, such that spatter is minimized and heat energy is reduced; and a main joint fill contribution may be determined and produced over a second period, so as to control weld pool shape and result in the desired joint strength. Finally, a crater fill contribution may be determined and produced over a third period. With respect to the arc initiation and crater fill periods, it is appreciated that the total wire contributions are preferably provided by the minimum wire contribution available.

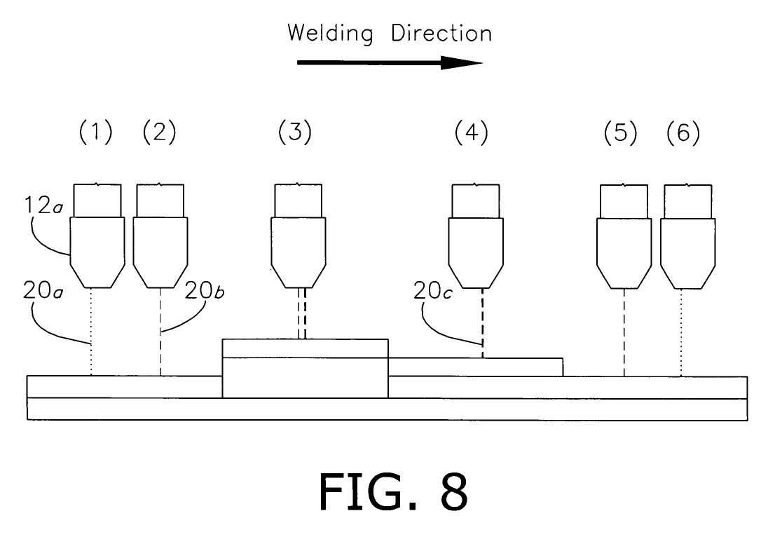

FIG. 8 illustrates the second mode of operation, and presents a complex stack of workpieces being welded in a single pass by a three wire GMAW system 10 having small, intermediate and large wire feeds 20. It is appreciated that complex stack configurations, as represented here, better reflect actual industrial application, and highlight the benefits of the present invention. At beginning phase (1) the torch nozzle 12a and workpieces are short-circuited so as to provide arc initiation typically for a duration of about 0.5 to 1 s. The smallest wire (with respect to diameter) is solely fed during this period with an appropriate arc initiation wire feed rate. At phase (2), arc initiation has been completed and main joint fill has commenced for a portion of the stack-up comprising two sheets. Here, the intermediate (or “working”) wire is fed, the nozzle 12a begins to translate so as to follow the proposed joint alignment, and the small wire feed is terminated. It is appreciated that phase (1) and the commencement of phase (2) occur co-spatially, but at different times. At phase (3), the stack-up changes to a portion comprising three sheets of a first height, and the large wire feed is added to the intermediate wire feed. At phase (4), the stack-up reflects a three sheet portion having a reduced height in comparison to phase (3). Here, the intermediate wire feed is terminated so that only the large wire feed remains. At phase (5) the stack-up returns to the configuration of phase (2), and as such, the intermediate wire is again solely fed. Finally, at phase (6) at the termination of the two-sheet stack-up and the welding pass, a crater fill wire contribution is provided, wherein the small wire is solely fed as at phase (1).

In an exemplary application, where two low carbon steel workpieces (0.8 mm and 1.2 mm thick) are to be welded, suitable total wire contribution during arc initiation may be provided by a steel wire (ER70-S3) having a 0.9 mm diameter, and a 200 ipm feed rate; during joint fill by a steel (ER70-S6) wire having a 1.1 mm diameter and a 500 ipm feed rate; and during crater fill by the ER70-S-3 wire at a 300 ipm feed rate.

It is appreciated that suitable makes and models of unmodified torch components, sensors 58,60, and drive mechanism components such as motors 38, wire reels 40, clutches 44, and rollers 54, as well as suitable controller programming, processing, and storage specifications are readily determinable by those of ordinary skill in the art without undue experimentation, and as such have not been further described herein.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention. The inventors hereby state their intent to rely on the Doctrine of Equivalents to determine and assess the reasonably fair scope of the present invention as it pertains to any apparatus, assembly, or method not materially departing from but outside the literal scope of the invention as set forth in the following claims.

What is claimed is:

1. A gas metal arc welding system adapted for welding a plurality of workpieces during a welding process, said system comprising:
a GMAW torch including a nozzle and handle, and defining at least one opening, wherein said opening terminates within the nozzle, said torch and workpieces being cooperatively configured to produce an intermediate electric arc and a heated zone having an operating temperature adjacent the arc, during the welding process;
a plurality of wire segments, each presenting a distal end and a melting temperature less than the operating temperature, said at least one opening being configured to concurrently receive the wire segments, such that each of the distal ends enter the zone; and
at least one advancing mechanism drivenly coupled to each of the segments, and configured to concurrently advance each of the segments into the zone at a predetermined feed rate.

2. The system as claimed in claim 1, wherein the segments present substantially differing diameters.

3. The system as claimed in claim 1, wherein the segments are formed of substantially differing compositions, such that each segment presents a different fluidity when molten.

4. The system as claimed in claim 1, wherein the segments are formed of substantially differing compositions, such that each segment produces a joint having a different shearing strength.

5. The system as claimed in claim 1, wherein the segments are formed of substantially differing compositions, such that each segment presents a different cohesive force when molten.

6. The system as claimed in claim 1, wherein a plurality of openings not less than the plurality of segments are defined by the torch, and each segment is received within a separate opening.

7. The system as claimed in claim 6, wherein the torch includes a contact tip, the tip defines a distal portion of each opening, and the portions and wire diameters are cooperatively configured such that the tip contacts each segment.

8. The system as claimed in claim 7, wherein the distal portions are configured to converge the segments towards a point within the zone.

9. The system as claimed in claim 1, wherein a plurality of independently operable mechanisms are drivenly coupled to the plurality of segments, and cooperatively configured to advance the segments into the zone at different feed rates.

10. The system as claimed in claim 9, wherein each of the plurality of mechanisms are configured to separately engage and disengage each of the segments.

11. The system as claimed in claim 10, wherein each of the mechanisms further include a separate motor and clutch element configured to selectively cause the motor to engage and disengage the segments.

12. The system as claimed in claim 9, further comprising:
a controller communicatively coupled to the mechanisms and programmably configured to autonomously actuate each of the mechanisms separately,
said controller and drive mechanisms being cooperatively configured to produce and modify the feed rates.

13. The system as claimed in claim 9, wherein the controller is configured to receive input, and cause the feed rates to be modified based upon the input.

14. The system as claimed in claim 13, further comprising:
a sensor positioned relative to the torch and workpieces and operable to determine a zone characteristic, during the welding process,
said sensor being configured to generate correlative zone characteristic data, and communicatively coupled to the controller such that the sensor is operable to convey and the controller is operable to receive the data, and the data is correlative to the input.

15. A gas metal arc welding system adapted for welding a plurality of workpieces during a welding process, said system comprising:
a GMAW torch including a nozzle and handle, and defining at least one opening, wherein said opening terminates within the nozzle, said torch and workpieces being cooperatively configured to produce an intermediate electric arc and a heated zone having an operating temperature adjacent the arc, during the welding process;
a plurality of wire segments having substantially differing diameters and compositions, and each further presenting a distal end and a melting temperature less than the operating temperature, wherein said at least one opening is configured to concurrently receive the wire segments, such that each of the distal ends enter the zone;
at least one advancing mechanism drivenly coupled to each of the segments, and configured to advance each of the segments into the zone at a predetermined feed rate; and
a controller communicatively coupled to and programmably configured to autonomously actuate said at least one mechanism, wherein said controller and said at least one mechanism are cooperatively configured to produce and modify the feed rates.

16. A method of welding a plurality of workpieces utilizing multiple independent wire feeds, wherein each workpiece presents a thickness and composition and each feed presents a wire composition, melting temperature, and diameter, said method comprising:
a. securing the feeds relative to the workpieces;
b. determining a first total wire contribution based on the workpiece thicknesses and compositions;
c. producing a heated zone adjacent the workpieces, wherein the zone presents a minimum operating temperature greater than each of the wire melting temperatures; and
d. determining a first feed rate for each of the feeds, and autonomously advancing said each of the feeds into the zone at the feed rate, so as to produce the first total wire contribution.

17. The method as claimed in claim 16, wherein steps b) and d) further include the steps of determining first and second asynchronous application periods, determining a second total wire contribution, producing the first total wire contribution over the first period, determining a second feed rate for each of the feeds, and autonomously advancing said each of the feeds into the zone at the second feed rate over the second period, so as to produce the second total wire contribution.

18. The method as claimed in claim 17, wherein the first application period is an arc initiation period, and the first feed rates are configured such that the first total wire contribution is the minimum wire contribution available.

19. The method as claimed in claim 18, wherein the second application period is a main joint welding period, and the second feed rates are configured such that the second total wire contribution provides a desired weld pool shape and chemistry.

20. The method as claimed in claim 16, wherein step d) further includes the steps of receiving feedback from the zone, and autonomously adjusting the feed rates based on the feedback, during welding.
